(19) United States
(12) Patent Application Publication
(10) Pub. No.: US 2011/0187325 A1
(43) Pub. Date: Aug. 4, 2011

(54) SYSTEM AND METHOD FOR BALANCING A BATTERY PACK

(76) Inventors: Po Chang Lin, Taipei Hsien (TW); Chong Yu Wang, Taipei Hsien (TW)

(21) Appl. No.: 12/685,100

(22) Filed: Feb. 4, 2010

(51) Int. Cl. H02J 7/00

(52) U.S. Cl. 320/116

(57) ABSTRACT

A system and method for balancing a battery pack is disclosed. The method includes the step of monitoring voltages for all batteries in the battery pack and if the voltages of any two batteries are out of balance, then, issuing a balancing command to charge the battery that is relatively lower in voltage between the two until the voltage of the battery attaining a preset voltage. The battery-pack balancing system includes a battery-monitoring unit and a battery-balancing unit. The battery-monitoring unit monitors the voltage of all the batteries in the battery pack and, when the voltages of any of the two batteries in the battery pack is out of balance, issues a balancing command to charge the battery that is relatively lower voltage in the battery pack.

### BACKGROUND OF THE INVENTION

1. Field of the Invention

The invention relates to a system and method for balancing a battery pack that consists of a multiplicity of batteries in series.

2. The Prior Art

The fact that the voltages of the batteries in a battery pack consisting of a multiplicity of batteries are all different since the charging and discharging electricity of each of the battery are out of balance. For example, in general, there are eight Lithium batteries with 24V (24 volts) in a Lithium battery pack and the voltage of each of the Lithium battery is around 3.2V. When one charges the Lithium battery pack, the charging action will terminate when the voltage of the battery pack attains a highest voltage such as 26V. However, in general, this 26V of voltage will not be uniformly distributed in the eight batteries, i.e., 26V/8=3.25V, rather, it can be the situation like this: some are overcharged like 3.5V while others are undercharged like 3.1V. In this way, the voltages of each of the batteries in the battery pack are hardly balanced. Especially, after the battery pack is used for a long period of time, the voltage difference among the batteries will gradually increase. Consequently, the performance of the battery pack will deteriorate or the battery pack becomes shorter in service life. This is the demerits of the prior art.

To overcome the above-mentioned problems, people in the field have developed a so-called balancing method to have all the batteries in a battery pack maintain equivalent voltage, and the equipment associated with the method is called a balancer, a constant-pressure apparatus, a uniform pressure apparatus, or a battery management system (BMS).

Currently, a common balancing method is to have those batteries having higher voltage become lower by resistance bleeding method or by transferring the electric charge from those batteries having higher voltage (relatively saturated charging) to those batteries having lower voltage through a capacitor mode. However, although the overall voltage difference is lowered by the above-mentioned methods, the objective of having a uniformly distributed voltage in the battery pack is still hardly achieved. What is more, these methods will result in waste of energy or requiring more complicated circuit structure to achieve the transferring of electric charge. What is more, the above-mentioned methods may extend the overall charging time for the battery pack. This is another demerits of the prior art.

### SUMMARY OF THE INVENTION

In light of above-mentioned demerits of the prior art, the invention provides a system and method for balancing the voltage of each of the battery in a battery pack consisting of a multiplicity of batteries in series that aims to ameliorate at least some of the demerits of the prior art or to provide a useful alternate.

In order to resolve the above-mentioned problems, the main objective of the invention is to provide methods for balancing the voltage of each of the battery in a battery pack that are speedy in balancing, easy to perform without wasting of energy for overcoming the insufficiency of today's technology.

To accomplish the above-mentioned objective of the invention, the following technological methods are employed:

Monitoring the voltages for all the batteries in the battery pack and if the voltage of any two batteries is out of balance, then issuing a balancing command to charge the battery that is relatively lower in voltage between the two until the voltage of the battery attaining a preset voltage.

Moreover, the embodiments of the above-mentioned methods are:
(1) monitoring the voltage of each of the battery in the battery pack by a battery-monitoring unit, and issuing a balancing command to a battery-balancing unit if the voltage difference between any two batteries or the voltage difference between the voltage of any battery and the average voltage exceeds a preset threshold value; and
(2) receiving the balancing command issued from the battery-monitoring unit by the battery-balancing unit, and charging the battery that is relatively lower in voltage in the battery pack until the voltage of the battery attain a preset voltage.

The methods include the following steps:
(1) receiving the voltage signal of each of the batteries in the battery pack by an ADC (Analog/Digital Converter) unit to convert into digital signal, and issuing to a data processing unit;
(2) receiving and processing the digital signal by a data processing unit, and issuing a balancing command to the battery-balancing unit if the value difference of the digital signal representing the voltage difference between any two batteries or the voltage difference between the voltage of any battery and the average voltage in the battery pack exceeds a threshold value preset in the data processing unit; and
(3) charging the battery that is relatively lower in voltage in the battery pack until the voltage of the battery attaining a preset voltage by a battery-balancing unit.

There is a threshold value stored beforehand in the data processing unit. When the value difference of the digital signal, which represents the voltage difference between any two batteries or the voltage difference between the voltage of any battery in the battery pack and the average voltage of all batteries in the battery pack, exceeds the threshold value, the data processing unit issues a balancing command.

There is also a high-voltage threshold value stored beforehand in the data processing unit, and when the digital signal, received by the data processing unit, representing the voltage of any battery in the battery pack exceeds the threshold value, the data processing unit issues a balancing command.

In the above-mentioned step (3), the battery-balancing unit charges the battery having relatively lower voltage in the battery pack through a switch circuit controlled by a switch-circuit control unit, which includes a plurality of parallel switch modules each of which is connected to each of the battery in the battery pack.

The operating status of the switch control circuit is controlled by a data processing unit that receives and processes the digital signal transmitted by the ADC unit, issues a control command to the switch-circuit control unit, and controls the actions of each of the switch module in the switch circuit.

The battery-balancing unit further includes a charging unit that includes at least one of a battery, a capacitor and a DC-DC or AC-DC converter.

The data processing unit further includes a processor.

The other objective of the invention is to provide a battery-pack balancing system applied to the above-mentioned balancing methods for the battery pack that are simple in structure, low in cost, and easy to operate, the technological schemes are as follows:

A battery-pack balancing system comprises:
(1) a battery-monitoring unit for monitoring the voltage of all the batteries in the battery pack and issuing a balancing command when the voltages of any of the two batteries in the battery pack is out of balance; and
(2) a battery-balancing unit receiving the balancing command issued by the battery-monitoring unit and charging the battery that is relatively lower in voltage in the battery pack.

The battery-pack balancing system further comprises:
(1) a switch circuit, having a plurality of parallel switch module each of the switch module is connected to each of the battery in a battery pack;
(2) a battery-monitoring unit, monitoring the voltage of each of the battery in the battery pack through the switch circuit and issuing a balancing command when the voltages of any of the two batteries in the battery pack is out of balance; and
(3) a battery-balancing unit, receiving a balancing command issued from the battery-monitoring unit, and charging the battery that is relatively lower in voltage in the battery pack until the voltage of the battery is raised to a preset voltage.

The battery-monitoring unit further comprises:
(1) an analog/digital converter (ADC) unit, receiving the voltage signals of each of the battery in the battery pack through the switch circuit, transforming into digital signals, and transmitting to a data processing unit;
(2) a data processing unit, receiving and processing the digital signal transmitted by the ADC unit, and issuing a controlling command to a switch-circuit control unit; and
(3) a switch-circuit control unit, receiving the control command issued by the data processing unit and controlling the actions of each of the switch module of the switch circuit.

The monitoring process of the battery-monitoring unit to any battery's voltage of the battery pack comprises the following steps:
(1) the data processing unit generates a control command;
(2) the switch-circuit control unit receives a control command to control the witch-on of the switch module corresponding to the above-mentioned battery in the switch circuit; and
(3) the ADC unit acquires the voltage signal of the battery through the switch circuit and converts into digital signal to be transmitted to the data processing unit.

There is a threshold value set up in the data processing unit, and when the value difference of the digital signal representing the voltage of any two batteries in the battery pack exceeds the threshold value, or when the value difference, between the digital signal representing the voltage of any battery in the battery pack and the digital signal representing the average value of the voltages of all batteries in the battery pack, exceeds the threshold value, the data processing unit issues a balancing command to the balancing unit.

There is a high-voltage threshold value set up in the data processing unit, and when the digital signal representing the voltage of any battery in the battery pack exceeds the high-voltage threshold value, the data processing unit issues a balancing command.

The battery-pack balancing system further comprises a charging unit that includes at least one of a battery, a capacitor and a DC-DC or AC-DC converter.

The switch circuit further comprises a battery anode connecting module and a corresponding battery cathode connecting module that further comprising respectively a plurality of battery anode connecting wires and battery cathode connecting wires furnished in parallel where the battery anode connecting wires and battery cathode connecting wires have at least a switch furnished thereof respectively. Moreover, the switches furnished in both the battery anode connecting wires and battery cathode connecting wires are combined into a switch module.

The data processing unit further comprises a processor.

In the light of the insufficient balancing methods performed for the battery pack, the inventor employs a technological conception that is quite different from the existing one of today to achieve an effective balancing method for balancing the battery pack. The method is capable of overcoming the insufficiency of the current technology. The essentials of the technological conception lie in that after finding out the difference in battery's voltage in the battery pack, the battery having relatively lower voltage in the battery pack is performed charging action by an externally furnished charging unit for performing extra compensation to attain a preset voltage (e.g. average voltage), i.e., a compensative method (energy pump or power pump) is employed to achieve balance in each of the battery in the battery pack.

The methods and facilities of the invention are disclosed as described above, and the working principle and process can be summarized as battery monitoring mode and battery balancing mode of synchronous or alternate performance.

### Battery Monitoring Mode:

The battery monitoring mode is to perform scanning action to the battery's voltage for each of the battery in the battery pack at the start-charging action, during the charging process, or after finishing the charging process. A concrete operation can be that the data processing unit issues a control command to order the switch-circuit control unit to control the operating status in each of the switch module in the switch circuit. For instance, through the order of the switch-circuit control unit, one can monitor the voltage of a certain battery to have the switch module, which is corresponding to the battery in the switch circuit, switch on. The voltage value of the battery is reported back to the data processing unit through the measurement of the ADC unit. After finishing the scanning action, one makes the switch module switch off again. Similarly, one can perform the voltage scanning for each of the battery in the battery pack.

### Battery Balancing Mode:

After finishing the scanning for the voltage of each of the battery in the battery pack, a balancing operation for the battery pack is required to perform and the battery balancing mode is begun to enter if any of the following conditions is conformed:
(1) The difference of the voltage value of any of two battery core exceeds the threshold value;
(2) The difference between the voltage value and the average voltage value of a certain battery core exceeds the threshold value; and
(3) The voltage value of any of the battery core exceeds a high threshold value.

Consequently, the data processing unit issues a balancing command to make the switch-circuit control unit control the switch-on status of the switch module that is corresponding to the battery needed to replenish electricity in the switch circuit. The data processing unit will also replenish electricity for the battery through the battery-balancing unit until the voltage of the battery raises to a predetermined voltage, at this moment, the charging action will be stopped.

In this way, the battery pack maintains synchronous or alternate performance for the battery monitoring mode and the battery balancing mode until the voltage difference among the batteries in the battery pack is within the preset threshold value.

### Efficacy of the Invention

Comparing with technology of today, the advantageous efficacy of the invention is listed as follows:
(1) The method of the invention is easy to execute and is capable of performing balancing process to the battery pack at all times;
(2) The charging process of the invention is speedy, highly efficient, and without waste of energy as the method of the invention is capable of achieving a basically same balancing speed during the charging process under the premise of not purposely delaying the charging speed to the battery having relatively higher voltage;
(3) The method of the invention is capable of being carried out without implementing complicated algorithm nor employing complicated facility and complicated circuit that ends up with low cost; and
(4) The invention is capable of widely applying in the balancing process of various battery packs to improve their performance and prolong their service life.

### BRIEF DESCRIPTION OF THE DRAWINGS

The accomplishment of this and other objectives and the range of suitability of the application of the invention will become apparent from the following description and its accompanying drawings of which:

FIG. 1 is a schematic diagram of the structure of a battery pack balancing system of the embodiments of the invention.

### DETAILED DESCRIPTION OF THE PREFERRED EMBODIMENT

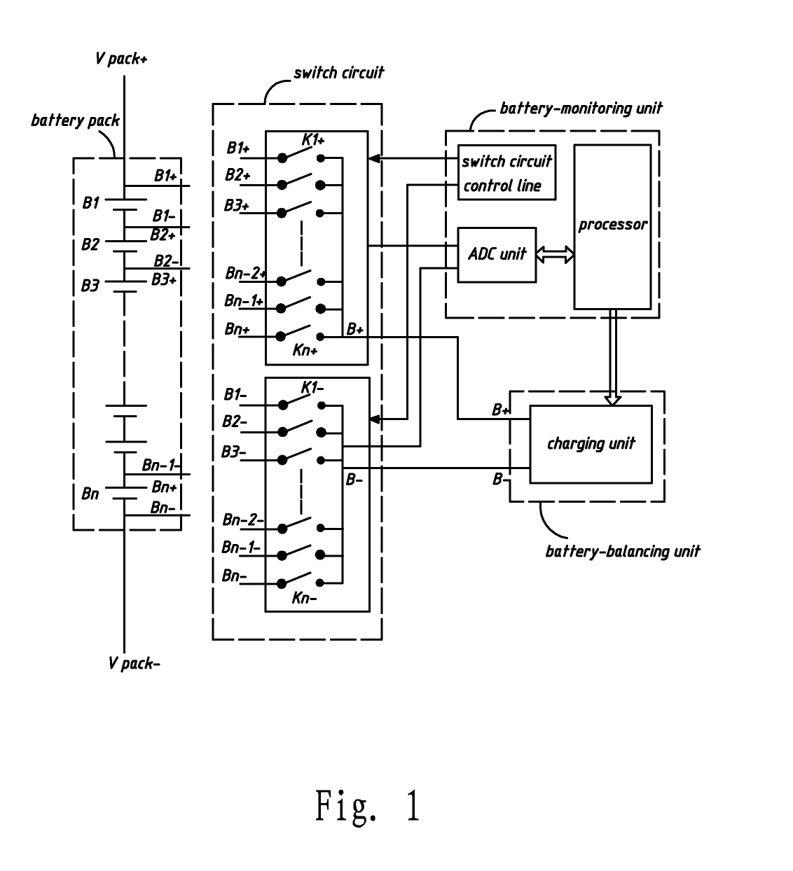

FIG. 1 is a schematic diagram of the structure of a battery pack balancing system of the embodiments of the invention. As shown in FIG. 1, the battery-pack balancing system, being used for performing balancing process to the battery pack, includes a multiplicity of batteries B₁, B₂, B₃, - - - , Bₙ, connected in series. These batteries can be a single-pack lead battery, a lithium battery, a nickel-metal-hydride battery, a nickel-cadmium battery pack etc.

The battery-pack balancing system includes a switch circuit, a battery-monitoring unit, and a battery-balancing unit.

The switch circuit includes a battery anode connecting module and a corresponding battery cathode connecting module. The battery anode connecting module further includes a plurality of battery anode connecting wires furnished in parallel where each of the battery anode connecting wires is correspondingly connected to anodes B₁+, B₂+, B₃+, - - - , Bₙ+ of each of the battery in the battery pack, and a switch K₁+, K₂+, K₃+, - - - , Kₙ+ is furnished thereof respectively. Similarly, the battery cathode connecting module further includes a plurality of battery cathode connecting wires furnished in parallel where each of the battery cathode connecting wires is correspondingly connected to cathodes B₁−, B₂−, B₃−, - - - , Bₙ− of each of the battery in the battery pack, and a switch K₁−, K₂−, K₃−, - - - , Kₙ− is furnished thereof respectively. The switches K₁+, K₂+, K₃+, - - - , Kₙ+ combines with switches K₁−, K₂−, K₃−, - - - , Kₙ− to form a plurality of switch modules.

The battery-monitoring unit includes:
(1) an analog/digital converter (ADC) unit, receiving the voltage signals of each of the battery in the battery pack through the switch circuit, transforming into digital signals, and transmitting to a data processing unit;
(2) a data processing unit, receiving and processing the digital signal transmitted by the ADC unit, and issuing a controlling command to a switch-circuit control unit, and in the data processing unit is also capable of issuing a balancing command to the battery-balancing unit under a specific condition; and
(3) a switch-circuit control unit, receiving the control command issued by the data processing unit and controlling the switch-off and switch-on actions of each of the switch module in the switch circuit.

The battery-balancing unit further includes a charging unit that has at least one of a battery, a capacitor and a DC-DC or AC-DC converter. The battery-balancing unit may further include other devices that are capable of achieving the charging function.

The specific condition making the data processing unit issue a balancing command is set up as follows:

First of all, a threshold value or a high voltage threshold value is set up in the data processing unit, then the data processing unit is capable of issuing a balancing command if one of the following conditions shows up:
(1) The value difference of the digital signal representing the voltage of any two batteries in the battery pack exceeds the threshold value;
(2) The value difference, between the digital signal representing the voltage of any battery in the battery pack and the digital signal representing the average value of the voltages of all batteries in the battery pack, exceeds the threshold value; and
(3) The digital signal representing the voltage of any battery in the battery pack exceeds the high voltage threshold value.

Of course, the data processing unit is capable of issuing balancing command and control command in synchronous or non-synchronous ways to make the switch-circuit control unit and the battery-balancing unit performs actions separately or in coordination.

When it comes to working on the battery pack balancing system, there are two working modes, one is a battery monitoring mode, and the other one is a battery balancing mode.

In the battery monitoring mode, it is understood that at the start-charging action, during the charging process, or after finishing the charging process, the battery-pack balancing system performs scanning action to the battery's voltage for each of the battery in the battery pack. Its concrete operation can be that the data processing unit issues a control command to order the switch-circuit control unit to control the operating status in each of the switch module in the switch circuit. For instance, when it comes to monitoring the voltage of the battery B1, the data processing unit issues an order through the switch-circuit control unit to switch on the switches K1+, K1− corresponding to the battery in the switch circuit. Consequently, the voltage value of the battery B1 is reported back to the data processing unit through the measurement of the ADC unit. After the scanning work is finished, the switch module, which consists of the switches K1+, K1−, is switched off again. In the same way, one can scan the voltage of the battery B₂, B₃, - - - , Bₙ in the battery pack in synchronous or non-synchronous ways.

In the battery balancing mode, it is understood that after finishing the scanning to the voltage of each of the battery in the battery pack by the battery-pack balancing system, a concrete operation for performing a balancing process to the battery voltage in the battery pack is as follows:

The data processing unit performs scanning to gain a digital signal that represents the voltage of each of the battery in the battery pack, and the processed result is compared with the threshold value or the high voltage threshold value to judge if it is necessary to issue a balancing command. If any of the following conditions is conformed, then it indicates that the battery pack needs to execute the balancing operation:
(1) The value difference of the digital signal representing the voltage of any of two batteries exceeds the threshold value;
(2) The value difference between the digital signal representing the voltage of any battery in the battery pack and the digital signal representing the average voltage of all the batteries in the battery pack exceeds the threshold value; and
(3) The value of the digital signal representing the voltage of any battery in the battery pack exceeds the high voltage threshold value.

Consequently, the processing unit synchronously issues a control command and a balancing command to make the switch-circuit control unit control the switch-on status of the switch module in the switch circuit where the switch module is corresponding to the battery (battery having relatively lower voltage) needed to replenish electricity in the switch circuit. The data processing unit will also replenish electricity for the battery through the battery-balancing unit until the voltage of the battery raises to a predetermined voltage, at this moment, the charging action will be stopped.

In this way, the battery pack maintains synchronous or alternate performance for the battery monitoring mode and the battery balancing mode until the voltage difference among the batteries in the battery pack is within the preset threshold value, i.e., to achieve the objective of making the voltage balance within the battery module.

It is known from the working mode of the battery-pack balancing system that the design concepts and the efficacies thereof is quite different from and is superior to that of the existing technology. For instance, comparing with the charging of the charging mode to the battery having relatively high voltage (battery having relatively saturated charging) of the prior art, the invention is capable of effectively economizing energy. What is more, comparing with the existing technology of the prior art, the invention employs the mode having a portion of the electric charge of the battery with relatively higher voltage in the battery pack (battery having relatively saturated charging) transfer to the battery with relatively lower voltage, the invention is capable of making each of the batteries attain equilibrium with relatively larger speed under the premise not to purposely delay the charging speed to charge the battery with relatively higher voltage. Accordingly, there is no need to design a circuit with complicated structure.

The above-mentioned data processing unit can include a processor. Certainly, in order to strengthen the function of the balancing system of the battery pack to satisfy the requirements in practical application, associated equipments such as memories, a communicating connecting ports, external facility interface etc. can be provided. Furthermore, the data processing unit can be selected from the equipments having data processing function like personal computer, single chip machine etc.

What is more, the above-mentioned switch circuit can employ other structures provided by technicians in the field who are capable of totally thinking of using the existing integrated circuit or performing simple changes to the existing integrated circuit to carry out the function of the switch circuit.

It will become apparent to those people skilled in the art that various modifications and variations can be made to the mechanism of the invention without departing from the scope or spirit of the invention. In view of the foregoing description, it is intended that all the modifications and variation fall within the scope of the following appended claims and their equivalents.

What is claimed is:

1. A method for balancing a battery pack, comprising the step of:
monitoring voltages for all batteries in the battery pack; if the voltage of any two batteries is out of balance, then issuing a balancing command to charge the battery that is relatively lower in voltage between the two batteries until the voltage of the battery attaining a preset voltage.

2. The method as claimed in claim 1, comprising the steps of:
(1) monitoring the voltage of each of the battery in the battery pack by a battery-monitoring unit; issuing the balancing command if a voltage difference between any two batteries exceeds a preset threshold value; and
(2) receiving the balancing command issued from the battery-monitoring unit by a battery-balancing unit, and charging the battery that is relatively lower in voltage in the battery pack until the voltage of the battery attain the preset voltage.

3. The method as claimed in claim 2, comprising the steps of:
(1) receiving a voltage signal of each of the batteries in the battery pack by an ADC (Analog/Digital Converter) unit to convert into a digital signal, and issuing the digital signal to a data processing unit;
(2) receiving and processing the digital signal by a data processing unit, and issuing the balancing command to the battery-balancing unit if value difference of the digital signal representing the voltage difference between any two batteries in the battery pack exceeds the threshold value preset in the data processing unit; and
(3) charging the battery that is relatively lower in voltage in the battery pack until the voltage of the battery attaining the preset voltage by the battery-balancing unit.

4. The method as claimed in claim 3, wherein the threshold value is stored beforehand in the data processing unit; when the value difference of the digital signal, which represents the voltage difference between any two batteries or the voltage difference between the voltage of any battery in the battery pack and an average voltage of all batteries in the battery pack, exceeds the threshold value, the data processing unit issues the balancing command.

5. The method as claimed in claim 3, wherein a high-voltage threshold value is stored beforehand in the data processing unit; when the digital signal, received by the data processing unit, representing the voltage of any battery in the battery pack exceeds the high-voltage threshold value, the data processing unit issues the balancing command.

6. The method as claimed in claim 3, wherein in the step (3), the battery-balancing unit charges the battery having relatively lower voltage in the battery pack through a switch circuit controlled by a switch-circuit control unit which includes a plurality of parallel switch modules each of which is connected to each of the battery in the battery pack.

7. The method as claimed in claim 6, wherein an operating status of the switch control circuit is controlled by the data processing unit; the data processing unit receives and processes the digital signal transmitted by the ADC unit, and issues a control command to the switch-circuit control unit; and the switch-circuit control unit received the control command issued from the data processing unit and control actions of each of the switch module in the switch circuit.

8. The method as claimed in claim 2, wherein the battery-balancing unit includes a charging unit that has at least one of a battery, a capacitor and a DC-DC or AC-DC converter.

9. The method as claimed in claim 3, wherein the data processing unit comprises a processor.

10. A battery-pack balancing system, comprising:
a battery-monitoring unit monitoring voltages of all batteries in a battery pack and issuing a balancing command when the voltages of any of the two batteries in the battery pack is out of balance; and
a battery-balancing unit receiving the balancing command issued by the battery-monitoring unit and charging the battery that is relatively lower in voltage in the battery pack.

11. The system as claimed in claim 10, comprising:
a switch circuit having a plurality of parallel switch module, each of the switch module is connected to each of the battery in the battery pack;
a battery-monitoring unit monitoring the voltage of each of the battery in the battery pack through the switch circuit and issuing the balancing command when the voltages of any of the two batteries in the battery pack is out of balance; and
a battery-balancing unit receiving a balancing command issued from the battery-monitoring unit, and charging the battery that is relatively lower in voltage in the battery pack until the voltage of the battery is raised to a preset voltage.

12. The system as claimed in claim 11, wherein the battery-monitoring unit comprises:
an analog/digital converter (ADC) unit, which receives voltage signals of each of the battery in the battery pack through the switch circuit, transforms the voltage signals into digital signals, and transmits the digital signals to a data processing unit;
a data processing unit, which receives and processes the digital signals transmitted by the ADC unit, and issues a control command to a switch-circuit control unit; and
a switch-circuit control unit, which receives the control command issued by the data processing unit and controls actions of each of the switch module of the switch circuit.

13. The system as claimed in claim 12, wherein a monitoring process of the battery-monitoring unit to any battery's voltage of the battery pack comprises the following steps:
(1) generating the control command by the data processing unit;
(2) receiving the control command and controlling the battery's closing of the above-mentioned corresponding switch module in the switch circuit by the switch-circuit control unit; and
(3) receiving the battery's voltage signal through the switch circuit by the ADC unit, converting into the digital signal and transmitting the digital signal to the data processing unit.

14. The system as claimed in claim 12, wherein a threshold value is provided in the data processing unit; when the value difference of the digital signal, which represents the voltage difference between any two batteries or the voltage difference between the voltage of any battery in the battery pack and an average voltage of all batteries in the battery pack, exceeds the threshold value, the data processing unit issues the balancing command to the balancing unit.

15. The system as claimed in claim 12, wherein a high-voltage threshold value is provided in the data processing unit; when the digital signal representing the voltage of any battery in the battery pack exceeds the high-voltage threshold value, the data processing unit issues the balancing command.

16. The system as claimed in claim 10, wherein the battery-pack balancing system comprises a charging unit that has at least one of a battery, a capacitor and a DC-DC or AC-DC converter.

17. The system as claimed in claim 11, wherein the battery-pack balancing system comprises a charging unit that has at least one of a battery, a capacitor and a DC-DC or AC-DC converter.

18. The system as claimed in claim 11, wherein the switch circuit comprises a battery anode connecting module and a corresponding battery cathode connecting module; the battery anode connecting module and the battery cathode connecting module respectively comprises a plurality of battery anode connecting wires and battery cathode connecting wires disposed in parallel; each of the battery anode connecting wires and the battery cathode connecting wires have at least one switch furnished thereof; the switches furnished in both the battery anode connecting wires and the battery cathode connecting wires are combined into a switch module.

19. The system as claimed in claim 12, wherein the data processing unit comprises a processor.
